(19) United States
(12) Patent Application Publication
(10) Pub. No.: US 2024/0414309 A1
(43) Pub. Date: Dec. 12, 2024

(54) NAKED-EYE 3D DISPLAY METHOD AND SYSTEM FOR 2D GAME

(71) Applicant: GUANG DONG FUTURE TECHNOLOGY CO., LTD., Shenzhen (CN)

(72) Inventors: Shu He, Shenzhen (CN); Wei Gao, Shenzhen (CN); Wanliang Xu, Shenzhen (CN)

(21) Appl. No.: 18/695,893

(22) PCT Filed: Sep. 28, 2022
(86) PCT No.: PCT/CN2022/122055

§ 371 Date: Mar. 27, 2024

(30) Foreign Application Priority Data
Sep. 28, 2021 (CN) 202111145477.5

(51) Int. Cl. H04N 13/279; A63F 13/52; H04N 13/268; H04N 13/293; H04N 13/383

(52) U.S. Cl. CPC H04N 13/279; A63F 13/52; H04N 13/268; H04N 13/293; H04N 13/383

(57) ABSTRACT

The present application provides a naked-eye 3D display method and system for a 2D game. The method provided in the present application comprises: obtaining human eye position parameters of a viewer, and calculating a viewing distance between a display screen and the viewer and a viewing angle at time T1; predicting a viewing distance and a viewing angle at time T2 according to gyroscope data and/or key position and force data; and according to the viewing distance, a shear angle and the viewing angle, converting a 2D game into a 3D game, and displaying same on a naked-eye 3D display device at T2. According to the present application, a display effect of a stereoscopic 3D view is perfect, thereby improving the game experience of a player.

### TECHNICAL FIELD

The present disclosure relates to the technical field of 3D games, and in particular, relates to a method and system for converting virtual 3D games to stereoscopic 3D games.

### BACKGROUND

With the development of electronic technology, the gaming industry is playing an increasingly significant role in people's leisure and recreational lives, a variety of games and gaming devices are being developed, and players are imposing higher and higher requirements on gaming experience. Vivid game pictures greatly enhance the player's experience.

Conventional game graphics are mostly 2D or virtual 3D. With technological advancements, stereoscopic 3D games have emerged. However, the visual effects of conventional stereoscopic 3D games still lack vividness, making it difficult to provide players with a truly immersive experience.

### SUMMARY OF THE INVENTION

In order to solve the above problem, the present disclosure provides a method and system for converting virtual 3D games to stereoscopic 3D games.

The present disclosure provides a method for converting virtual 3D games to stereoscopic 3D games, including:
S01, acquiring eye position parameters of a viewer, and calculating a viewing distance and a viewing angle between a screen and the viewer at time T1 based on the eye position parameters;
S02, predicting a viewing distance and a viewing angle at time T2 based on gyroscope data and/or button positions and force data; and
S03, converting a 2D game to a 3D game and displaying the 3D game on a naked-eye 3D display device at time T2 based on the viewing distance, a shear angle, and the viewing angle.

Preferably, converting the 2D game to the 3D game in S03 includes:
S031, rotating an original game 3D view matrix of the game to obtain a stereoscopic view matrix based on the viewing angle;
S032, shearing the stereoscopic view matrix based on the shear angle to obtain stereoscopic views from two or more view points;
S033, converting the stereoscopic views from the two or more view points to views in a predetermined format;
S034, performing layout interlacing processing for the views in the predetermined format to acquire 3D game views to be rendered; and
S035, performing rendering interlacing processing for the 3D game views to be rendered to generate 3D game views.

Preferably, a formula for calculating the shear angle is calculated is:
wherein coordinates of any point in the stereoscopic views are defined as (x′, y′, z′), sheared coordinates are (x″, y″, z″), and θ is defined as the shear angle and represents an included angle between coordinates of a view point and a positive direction of a z′ axis, t represents an adjustment coefficient and 0<t<1;
a shear expression of an X-axis negative view point is:

$${x}^{″} = {x}^{′} + {z}^{′} * tan ( t * θ ) , {y}^{″} = {y}^{′} , {z}^{″} = {z}^{′} ;$$

and
a shear expression of an X-axis positive view point is:

$${x}^{″} = {x}^{′} - {z}^{′} * tan ( t * θ ) , {y}^{″} = {y}^{′} , {z}^{″} = {z}^{′} ;$$

Preferably, a formula for calculating the rotating is:
wherein using a screen center as an origin of a coordinate system O-XYZ, an angle between a projection of a connection line from eyes to the screen center on an XOZ plane and a positive half of a Z axis is α, an angle between a projection of the connection line from the eyes to the screen center on a YOZ plane and the positive half of the Z axis is β, and an X-axis direction points from a left screen center to a right screen center;
based on the angle α, the angle β, a distance L from the eyes to the screen, and a distance Z from a scene center to the screen, an angle by which a scene rotates around a Y axis is determined as:

a=arctan(L*tanα/(L+Z)), and

and
an angle by which the scene rotates about an X axis is determined as:

b=arctan(L*tanβ/(L+Z)).

Preferably, step S01 includes:
S011, capturing a facial image by a front camera, and recording image capture time as T1;
S012, calculating facial image feature points using an AI model; and
S013, calculating the viewing distance and the viewing angle based on feature point dimensions and positions of the facial image of a same user during 3D effect calibration.

Preferably, step S02 includes:
S021, continuously sampling the gyroscope and queuing sampled data;
S022, acquiring posture data at time T1 and posture data at current time T of a device, and predicting posture changes of the device from time T to time T2 using a 9-dimensional data AI model; and
S023, calculating a viewing distance and a viewing angle at time T based on the viewing distance and the viewing angle at time T1, and superimposing the posture changes to acquire the viewing distance and the viewing angle at time T2.

Preferably, based on the gyroscope data and/or the button positions and force data in S02 includes:
S02a, configuring a touch screen as a button force sensor;
S02b, establishing an AI model for button force and button positions for posture change training; and
S02c, predicting posture changes based on button force and button positions during a continuous gaming process using the AI model.

Preferably, before step S01, The present disclosure further includes:
Sa1 prior to start of the game, setting a flag, wherein the flag at least includes a start state and a stop state; and
Sa2, setting the flag to the start state in the case that the game can be converted into a stereoscopic 3D game, and setting the flag to the stop state in the case that the game can not be converted into a stereoscopic 3D game; or, wherein the flag flips between starting/stopping in the case that users click a 2D/3D switch key.
Sa3, determining whether an eye tracking module and an correcting module start to work based on the flag;
Sa4, determining whether to obtain the display data of the 2D game and convert it into a stereoscopic 3D game based on the flag.

The present disclosure further provides a naked-eye 3D display system for 2D games, including:
an eye tracking and positioning module, configured to acquire eye position parameters of a viewer, and calculate a viewing distance and a viewing angle based on the eye position parameters;
a 3D view generating module, configured to determine a rotation angle and a shear angle based on the viewing distance and the viewing angle, and convert a 2D game to a 3D game and display the 3D game on a naked-eye 3D display device;
a display module, configured to perform layout interlacing processing for the views in the predetermined format to generate 3D game views; and
a raster, configured to perform layout interlacing processing for the views in the predetermined format received by the display module.

Preferably, further including a 3D game management module, in gaming, configured to adjust 3D display parameters of the 2D games.

Preferably, further including a gyroscope and a force sensor.

Compared to conventional technologies, the method and system for converting virtual 3D games to stereoscopic 3D games according to the present disclosure achieve the following beneficial effects:

In the method for converting virtual 3D games to stereoscopic 3D games according to the present disclosure, first, the eye position parameters of the viewer are acquired; based on the eye position parameters, the rotation angle and the shear angle are determined; the original virtual 3D view matrix of the game is rotated based in the rotation angle to obtain the stereoscopic view matrix, and the stereoscopic view matrix is sheared based on the shear angle to obtain stereoscopic views from the view points; next, the stereoscopic views from the view points are converted to the views in the predetermined format; and these views in the predetermined format are subjected to layout interleaving processing followed by rendering interleaving processing, and finally vivid stereoscopic 3D game views are generated. Through these steps, the method for converting virtual 3D games to stereoscopic 3D games according to the present disclosure can transform the conventional virtual 3D game scenes to stereoscopic 3D game scenes. Upon the rendering interleaving processing, the display effect of the final stereoscopic 3D game scene is better, and a better immersive experience is provided for the players, and the overall gaming experience of the players is significantly enhanced.

In the method for converting virtual 3D games to stereoscopic 3D games according to the present disclosure, prior to start of the game, a flag is set, determine whether to start a game in a stereoscopic 3D mode based one the state of the flag, proceeded to S1 in the case that the game is started in the stereoscopic 3D mode, and stop proceeding and end this process in the case that the game is not started in the stereoscopic 3D mode. By setting this flag, the gaming system is allowed to determine immediately whether the game can be converted into a stereoscopic 3D game with stereoscopic views. Additionally, the player may manually set a display mode of the game, such that the gaming experience is enhanced.

In the method for converting virtual 3D games to stereoscopic 3D games, during acquisition of the eye position parameters, such as the eye distance and the eye rotation angle, of the viewer, through the cooperation of the gyroscope and either a camera or an infrared device, the frequency and accuracy of parameter acquisition are significantly improved. This substantial increases the parameter acquisition frequency, and effectively reduces the image latency caused by movements of the stereoscopic 3D game screen relative to the player, thereby greatly enhancing the gaming experience of the player. Moreover, the enhanced accuracy of the acquired eye position parameters ensures a higher precision in both the rotation angle and the shear angle. This allows the views to appropriately rotate and shear when the player looks at different angles, and hence achieves more vivid and realistic stereoscopic 3D views, thereby providing players with a better immersive gaming experience.

In the method for converting virtual 3D games to stereoscopic 3D games according to the present disclosure, by subjecting the views in the predetermined format to layout interleaving processing and row rendering interleaving processing, the resulting stereoscopic 3D game views are made more vivid and realistic. This optimizes gaming visual experience of the players, further enhances immersive experience of the players, and significantly improves overall gaming experience of the players.

In the method converting virtual 3D games to stereoscopic 3D games according to the present disclosure, the players may adjust the shear angle based on their own feelings and needs to enhance or weaken the stereoscopic parallax of the final views, and adjust the strength of the 3D stereoscopic effect. In this way, 3D motion sickness is reduced, and the 3D experience is enhanced.

The present disclosure further provides a system for converting virtual 3D games to stereoscopic 3D games. The system at least includes an eye tracking and positioning module, a 3D view generating module, and a display module. The system achieves the same beneficial effects as the method for converting virtual 3D games to stereoscopic 3D games as described above, which are not described herein any further.

### BRIEF DESCRIPTION OF THE DRAWINGS

For clearer descriptions of technical solutions according to the embodiments of the present disclosure, drawings that are to be referred for description of the embodiments are briefly described hereinafter. Apparently, the drawings described hereinafter merely illustrate some embodiments of the present disclosure. Persons of ordinary skill in the art may also derive other drawings based on the drawings described herein without any creative effort.

FIG. 1 is a schematic flowchart of steps of a naked-eye 3D display method for 2D games according to the present disclosure;

FIG. 2 is a schematic flowchart of converting a 2D game to a 3D game in step S03 in FIG. 1;

FIG. 3 is a schematic flowchart of step S01 in FIG. 1;

FIG. 4 is a schematic flowchart of step S02 in FIG. 1;

FIG. 5 is a schematic diagram of predicting a viewing distance and a viewing angle on gyroscope data and/or button positions and force data; and

FIG. 6 is a schematic diagram of a naked-eye 3D display system for 2D games according to the present disclosure.

### DETAILED DESCRIPTION

The technical solutions contained in the embodiments of the present disclosure are described in detail clearly and completely hereinafter with reference to the accompanying drawings for the embodiments of the present disclosure. Apparently, the described embodiments are only a portion of embodiments of the present disclosure, but not all the embodiments of the present disclosure. Based on the embodiments of the present disclosure, all other embodiments derived by persons of ordinary skill in the art without any creative efforts shall fall within the protection scope of the present disclosure.

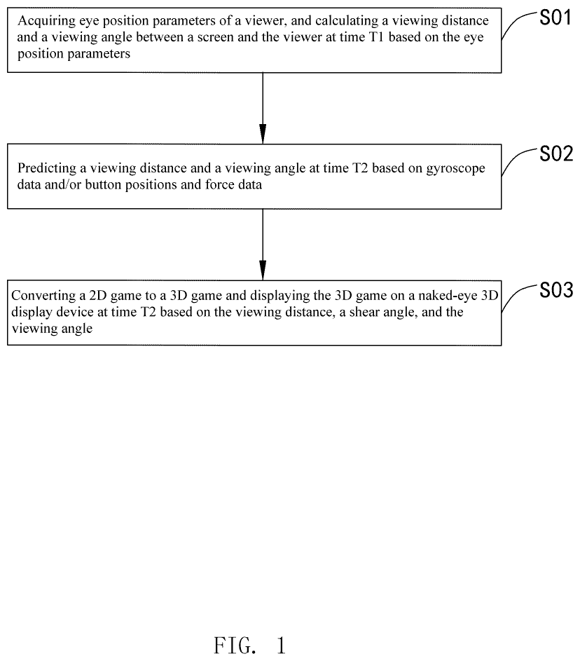

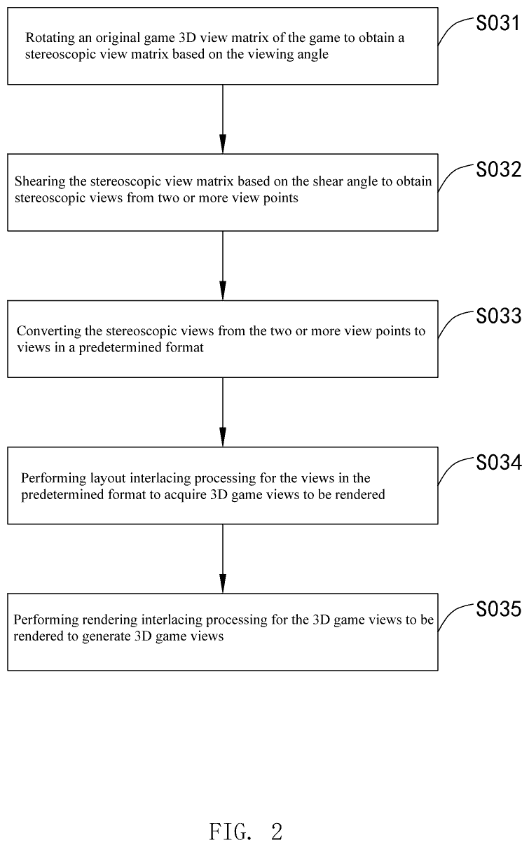

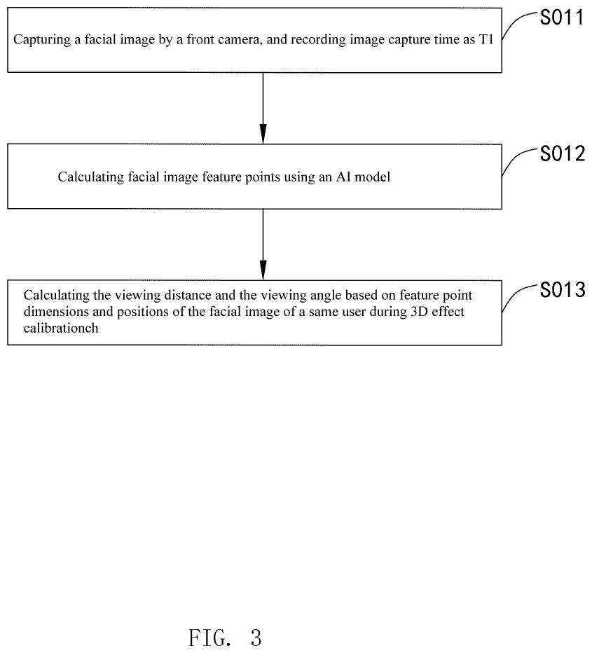

Referring to FIG. 1 to FIG. 3, a first embodiment of the present disclosure provides a naked-eye 3D display method for 2D games. The method includes:
S01, acquiring eye position parameters of a viewer, and calculating a viewing distance and a viewing angle between a screen and the viewer at time T1 based on the eye position parameters;
S02, predicting a viewing distance and a viewing angle at time T2 based on gyroscope data and/or button positions and force data; and
S03, converting a 2D game to a 3D game and displaying the 3D game on a naked-eye 3D display device at time T2 based on the viewing distance, a shear angle, and the viewing angle.

Step S01 includes:
S011, capturing a facial image by a front camera, and recording image capture time as T1;
S012, calculating facial image feature points using an AI model; and
S013, calculating the viewing distance and the viewing angle based on feature point dimensions and positions of the facial image of a same user during 3D effect calibration.

Step S02 includes:
S021, continuously sampling the gyroscope and queuing sampled data;
S022, acquiring posture data at time T1 and posture data at current time T of a device, and predicting posture changes of the device from time T to time T2 using a 9-dimensional data AI model; and
S023, calculating a viewing distance and a viewing angle at time T based on the viewing distance and the viewing angle at time T1, and superimposing the posture changes to acquire the viewing distance and the viewing angle at time T2.

Predicting the viewing distance and the viewing angle at the T2 based on the gyroscope data and/or the button positions and force data in S02 includes:
S02a, configuring a touch screen as a button force sensor;
S02b, establishing an AI model for button force and button positions for posture change training; and
S02c, predicting posture changes based on button force and button positions during a continuous gaming process using the AI model.

Converting the 2D game to the 3D game in S03 includes:
S031, rotating an original game 3D view matrix of the game to obtain a stereoscopic view matrix based on the viewing angle;
S032, shearing the stereoscopic view matrix based on the shear angle to obtain stereoscopic views from two or more view points;
S033, converting the stereoscopic views from the two or more view points to views in a predetermined format;
S034, performing layout interlacing processing for the views in the predetermined format to acquire 3D game views to be rendered; and
S035, performing rendering interlacing processing for the 3D game views to be rendered to generate 3D game views.
a formula for calculating the shear angle is calculated is:
wherein coordinates of any point in the stereoscopic views are defined as (x′, y′, z′), sheared coordinates are (x″, y″, z″), and θ is defined as the shear angle and represents an included angle between coordinates of a view point and a positive direction of a z′ axis, t represents an adjustment coefficient and 0<t<1;
a shear expression of an X-axis negative view point is:

$${x}^{″} = {x}^{′} + {z}^{′} * tan ( t * θ ) , {y}^{″} = {y}^{′} , {z}^{″} = {z}^{′} ;$$

and
a shear expression of an X-axis positive view point is:

$${x}^{″} = {x}^{′} - {z}^{′} * tan ( t * θ ) , {y}^{″} = {y}^{′} , {z}^{″} = {z}^{′} .$$

A formula for calculating the rotating is:
wherein using a screen center as an origin of a coordinate system O-XYZ, an angle between a projection of a connection line from eyes to the screen center on an XOZ plane and a positive half of a Z axis is α, an angle between a projection of the connection line from the eyes to the screen center on a YOZ plane and the positive half of the Z axis is β, and an X-axis direction points from a left screen center to a right screen center;
based on the angle α, the angle β, a distance L from the eyes to the screen, and a distance Z from a scene center to the screen, an angle by which a scene rotates about a Y axis is determined as:

a=arctan(L*tanα/(L+Z)), and
and
an angle by which the scene rotates about an X axis is determined as:

b=arctan(L*tanβ/(L+Z)).

The present disclosure further provides a naked-eye 3D display system for 2D games. The system includes:
an eye tracking and positioning module, configured to acquire eye position parameters of a viewer, and calculate a viewing distance and a viewing angle based on the eye position parameters;
a 3D view generating module, configured to determine a rotation angle and a shear angle based on the viewing distance and the viewing angle, and convert a 2D game to a 3D game and display the 3D game on a naked-eye 3D display device;
a display module, configured to perform layout interlacing processing for the views in the predetermined format to generate 3D game views; and
a raster, configured to perform layout interlacing processing for the views in the predetermined format received by the display module.

The system further includes a 3D game management module, configured to, in gaming, configured to adjust 3D display parameters of the 2D games.

The system further includes a gyroscope and a force sensor.

Based on the naked-eye 3D display method for 2D games, conventional virtual 3D game views may be converted to stereoscopic 3D game views. This greatly enhances the display effect of stereoscopic 3D views, allowing game players to have a better immersive experience and significantly improving their overall gaming experience.

Further, prior to S1, the method further includes:
Sa, determining whether to start a game in a stereoscopic 3D mode, and proceeding to S1 in the case that the game is started in the stereoscopic 3D mode, and ending this process in the case that the game is not started in the stereoscopic 3D mode.

Further, step Sa specifically includes:
Sa1 prior to start of the game, setting a flag, wherein the flag at least includes a start state and a stop state; and
Sa2, setting the flag to the start state and proceeding to S1 in the case that the game is in a virtual 3D format, and setting the flag to the stop state and ending the process in the case that the game is in a non-virtual 3D format.

Specifically, as an embodiment, upon step Sa2, the method further includes:
Sa3, determining whether a stop and start signal set by the view is detected, proceeding to S1 in the case that the stop and start signal is detected, and ending the process in the case that the stop and start signal is not detected.

By setting this flag, the gaming system is allowed to determine immediately whether the game can be converted into a stereoscopic 3D game with stereoscopic views. Additionally, the player may manually set a display mode of the game, such that the gaming experience is enhanced.

Furthermore, the eye position parameters at least include an eye distance and an eye rotation angle, and at least one parameter of the eye position parameters is acquired by a gyroscope. Moreover, the eye position parameters are acquired through cooperation of a gyroscope and a camera or a gyroscope and an infrared device. Conventional cameras generally output data every 33 ms. Therefore, when the relative position between the player and the game screen changes, there may be a significant delay in updating the stereoscopic 3D game screen. The gyroscope outputs data at a rate of 1000 times per second, i.e., every 1 ms. Through the cooperation of the gyroscope and either a camera or an infrared device, the frequency and accuracy of parameter acquisition are significantly improved. This substantial increases the parameter acquisition frequency, and effectively reduces the image latency caused by movements of the stereoscopic 3D game screen relative to the player, thereby greatly enhancing the gaming experience of the player. Moreover, the enhanced accuracy of the acquired eye position parameters ensures a higher precision in both the rotation angle and the shear angle. This allows the views to appropriately rotate and shear when the player looks at different angles, and hence achieves more vivid and realistic stereoscopic 3D views, thereby providing players with a better immersive gaming experience.

Further, the eye distance is a distance between the eyes and the screen center; and the eye rotation angle is an angle change between the eyes and the screen center.

Specifically, as an embodiment, in the method for converting the virtual 3D games to the stereoscopic 3D games according to the first embodiment of the present disclosure, the stereoscopic views from various view points are specifically calculated as follows:
Sb, in a space with the screen center as the origin of the three-dimensional coordinate system O-XYZ, calculating an angle α by which the scene rotates about the Y axis and an angle β by which the scene rotates about the X axis based on the distance from the eyes to the screen and the distance from the scene center to the screen;
Sc, based on the angle change between the eyes and the screen center, calculating an angle c by which the viewer and the screen center rotate about the Y axis and an angle d by which the viewer and the screen center rotate about the X axis;
Sd, acquiring a first rotation matrix and a second rotation matrix based on the angle a, the angle b, the angle c, and the angle d; and
Se, right-multiplying a virtual view matrix by the first rotation matrix and the second rotation matrix to acquire a stereoscopic view matrix.

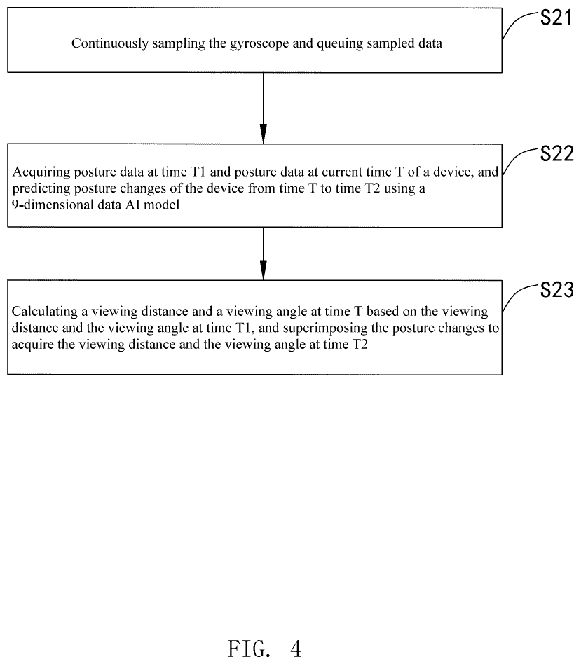

Referring to FIG. 4, specifically, an angle between a projection of a connection line from the eyes to the screen center on an XOZ plane and a positive half of a Z axis is α, and an angle between a projection of the connection line from the eyes to the screen center on a YOZ plane and the positive half of the Z axis is β; wherein the X axis is oriented in the same direction as a left-right direction of the screen, with the positive direction of the X axis pointing from a left center of the screen to a right center of the screen; and the Y axis is oriented in the same direction of an up-down direction of the screen, with the positive direction of the Y axis pointing from an upper center of the screen to a lower center of the screen. Based on the angles α and β, and a distance H from the eyes to the screen, and a distance J from the scene center to the screen, the angle a by which the scene rotates about the Y axis may be determined as:

a=arctan(H×tanα/(H+J)), and

The angle b by which the scene rotates about the X axis may be determined as:

b=arctan(H×tanβ/(H+J)).

An angle between the eyes and the screen center is V1 (aax1, aay1, aaz1) upon acquisition of eye positions, an angle between the eyes and the screen center is V2 (aax2, aay2, aaz2) prior to output of a stereoscopic view matrix, and angle data V changing between the eye positions and the screen centers is acquired based on V1 and V2.

$$V = V 2 - V 1 = ( aax 2 - aax 1 , aay 2 - aay 1 , aaz 2 - aaz 1 )$$

The angle c by which the viewer and the screen center rotate about the Y axis may be determined based on the changing angle data V:

$$c = a + aax 2 - aax 1$$

The angle d by which the viewer and the screen center rotate about the X axis may be determined based on the changing angle data V:

$$d = b + aay 2 - aay 1$$

Based on the angle c by which the viewer and the screen center rotate about the Y axis and the angle d by which the viewer and the screen center rotate about the X axis, a first rotation matrix M1 and a second rotation matrix M2 are acquired. M1 and M2 are represented by:

$$M 1 = \begin{matrix}cos c & 0 & - sin c \\ 0 & 1 & 0 \\ sin c & 0 & cos c\end{matrix} \\ M 2 = \begin{matrix}cos d & 0 & - sin d \\ 0 & 1 & 0 \\ sin d & 0 & cos d\end{matrix}$$

The virtual view matrix prior to rotation is represented by A, and the stereoscopic view matrix is represented by A′, then:

$${A}^{′} = M 1 \cdot M 2 \cdot A$$

As a preferred embodiment, upon step S3, the method further includes:

Sf, analyzing a facial image of the viewer, and adjusting the distance from the scene center to the screen and/or the shear angle based in an analysis result.

A shear matrix is generated based on the adjusted distance from the scene center to the screen and/or the adjusted shear angle, and the stereoscopic views from the view points are generated using the shear matrix and the stereoscopic view matrix.

Based on the above steps, it is possible to analyze the viewer's facial image and adjust the distance from the scene center to the screen and/or the shear angle based on the analysis result. According to the present disclosure, the shear matrix is updated in real time depending on different viewers, which provides optimal stereoscopic views and significantly enhances the viewing experience of the viewer.

Furthermore, the specific adjustment method of the distance from the scene center to the screen and/or the size of the shear angle in step Sf is: acquiring a distance between a left eye and a right eye of the viewer, and based on this distance, adding a distance L predetermined in advance to the distance from the screen to the scene center and/or multiplying the shear angle by a corresponding adjustment coefficient t to obtain an adjusted distance between the screen and the scene center and/or an adjusted shear angle, wherein 0<t<1, and the distance L and the adjustment coefficient t may be set by the viewer himself.

Specifically, a new coordinate system obtained upon rotation is represented by O′-X′Y′Z′, an origin O′ is coincident with the origin of the original O-XYZ three-dimensional coordinate system, the positive direction of a Z′ axis points to center coordinates of the view point along the coordinates of the viewer in the original coordinate system, transformation of the adjusted shear angle means that y′ and z′ of the view point are unchanged, the value of x′ represents a linear transformation with the z′ axis as a dependent axis, and setting the shear angle θ refers to an included angle between the coordinates of the view point and the positive direction of the z ‘axis, and the coordinates (x’, y′, z′) of any point in the scene are transformed to (x″, y″, z″) upon shearing. According to the stereo view matrix and the shear angle, it can be seen that a shear expression of the X axis negative view point is:

$${x}^{″} = {x}^{′} + {z}^{′} * tan ( t * θ ) ; {y}^{″} = {y}^{′} ; {z}^{″} = {z}^{′} .$$

A shear expression of an X-axis positive view point is:

$${x}^{″} = {x}^{′} - {z}^{′} * tan ( t * θ ) ; {y}^{″} = {y}^{′} , {z}^{″} = {z}^{′} .$$

By the above formula, it is possible to adjust the shear angle according to the distance between the left eye and the right eye of the viewer, so as to obtain an optimal stereoscopic view throw angle of the left and right eyes. I addition, the value of the adjustment coefficient t is limited to be between 0 and 1, such that the phenomenon that the shear angle is too large and the stereoscopic view is excessively deformed is avoided.

As a preferred embodiment, upon step S4, the method further includes:

Sg, automatically adjusting a parallax of the stereoscopic views based on values of the virtual views on the Z axis and preset threshold values.

Specifically, in the process of converting a virtual view matrix into a stereoscopic view, there is a situation where z′ is excessively large or small, and the parallax of a partial area of a sheared stereoscopic view is excessively large or small, which causes dizziness of the viewer. consequently, the viewing experience is affected. The embodiments of the present disclosure avoid this phenomenon by automatically adjusting the parallax of the stereoscopic view smoothly via z′. Specifically, zg and zt are predetermined thresholds on the Z axis, and the viewer can may the magnitude of zg and zt on his own, and the shear expression of the X axis negative view point upon adjustment is:

$${x}^{″} = {x}^{′} + {z}^{′} \times tan ( t \times θ ) \times ( 1 - tanh ( ( {z}^{′} - zg ) / zt )$$

$${y}^{″} = {y}^{′}$$

$${z}^{″} = {z}^{′}$$

Therefore, the shear matrix is:

$$\begin{matrix}1 & 0 & tan ( t \times θ ) \times ( 1 - tanh ( ( {z}^{′} - zg ) / zt ) ) \\ M 3 = 0 & 1 & 0 \\ 0 & 0 & 1\end{matrix}$$

The adjusted shear matrix at the X axis positive view point is:

$$\begin{matrix}1 & 0 & - tan ( t \times θ ) \times ( 1 - tanh ( ( {z}^{′} - zg ) / zt ) ) \\ M 3 = 0 & 1 & 0 \\ 0 & 0 & 1\end{matrix}$$

The shear matrix M3 is right-multiplied by a stereoscopic view matrix corresponding thereto to generate a stereoscopic view A″ of each view point, such that automatic adjustment of the parallax of the stereoscopic views is achieved.

$${A}^{″} = M 3 \cdot {A}^{′} = M 3 \cdot M 1 \cdot M 2 \cdot A$$

As a specific embodiment, in the method for converting virtual 3D games to stereoscopic 3D games according to the first embodiment of the present disclosure, the eye position parameters are acquired through the cooperation of a gyroscope with a camera.

Furthermore, in the method for converting virtual 3D games to stereoscopic 3D games according to the first embodiment of the present disclosure, the stereoscopic views from the view points are converted to the views in a predetermined format. The predetermined format may be a left-right format, a top-bottom format, or a grid format. Specifically, as an embodiment, in this method, the stereoscopic views of the view point are converted to views in the left-right format.

Further, by subjecting the views in the predetermined format to layout interleaving processing and row rendering interleaving processing, the resulting stereoscopic 3D game views are made more vivid and realistic. This optimizes gaming visual experience of the players, further enhances immersive experience of the players, and significantly improves overall gaming experience of the players.

Optionally, prior to step S7, the shear angle may be adjusted based on a setting parameter of the viewer. Specifically, the players may adjust the setting parameter according to their own needs or choose not to adjust the setting parameter. When the players adjust the setting parameter based on their own feelings and needs, the shear angle changes accordingly in response to the change of the setting parameter. This change enhances or weakens the stereoscopic parallax of their stereoscopic 3D game views, and hence adjusts the strength of the 3D stereoscopic effect. This eventually reduces 3D motion sickness and enhances the 3D experience. When the players choose not to adjust the setting parameter based on their own feelings and needs, the value of the shear angle is calculated based on the eye position parameters obtained in step S2.

Optionally, the setting parameters may be adjusted over a UI interface or by using buttons, with no specific limitations on the adjustment method. Specifically, as an embodiment, in the method for converting virtual 3D games to stereoscopic 3D games according to the first embodiment of the present disclosure, the setting parameters are adjusted over the UI interface.

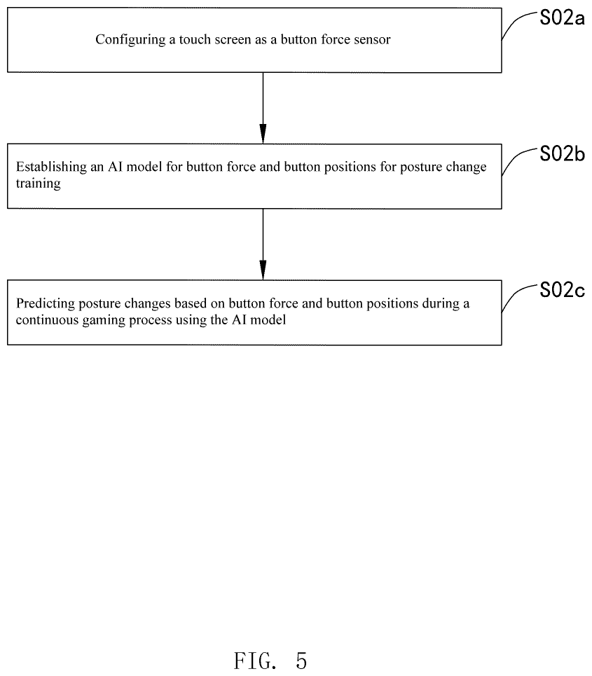

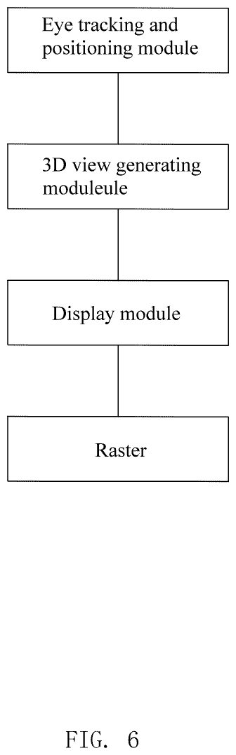

Referring to FIG. 5 and FIG. 6, a second embodiment of the present disclosure provides a system 1 for converting a virtual 3D game to a stereoscopic 3D game. The system 1 at least includes an eye tracking and positioning module 12, a 3D view generating module 13, and a display module 14.

Further, the eye tracking and positioning module 12 at least includes a gyroscope (not illustrated), configured to acquire eye position parameters of a viewer, wherein the eye position parameters at least include an eye distance and an eye rotation angle.

Further, the 3D view generating module 13 is configured to first determine a rotation angle and a shear angel based on the eye position parameters, secondly rotate an original virtual 3D view matrix of the game based on the rotation angle to obtain a stereoscopic view matrix and shear the stereoscopic view matrix based on the shear angle to obtain stereoscopic views from various view points, then convert the stereoscopic views at the various view points to views in a predetermined format, and finally transmit the views in the predetermined format to the display module 14. The display module 14 at least includes a raster (not illustrated). The display module 14 performs layout interlacing processing for the received views in the predetermined format based on physical parameters of the raster to acquire 3D game views to be rendered, and then the display module 14 performs rendering interlacing processing for the 3D game views to be rendered to generate final stereoscopic 3D game views. By subjecting the views in the predetermined format to layout interleaving processing and row rendering interleaving processing, the resulting stereoscopic 3D game views are made more vivid and realistic. This optimizes gaming visual experience of the playes, further enhances immersive experience of the players, and significantly improves overall gaming experience of the players.

Optionally, the system 1 further includes a stereoscopic 3D game start module 11, configured to determine whether the game is started in a stereoscopic 3D mode. In the case that the game is started in the stereoscopic 3D mode, the system continues to operate; and in the case that the game is not started in the stereoscopic 3D mode, the system stops operating.

Specifically, the stereoscopic 3D game start module 11 operates in accordance with the following principles: Prior to start of the game, the stereoscopic 3D game start module 11 at least include a flag (not illustrated), wherein the flag at least supports two states, a start state and a stop start, the flag is in the start state and the process proceeds to step Sa3 or S1 in the case that the game is in a virtual 3D format, and the flag is in the stop state and the process ends in the case that the game is in a non-virtual 3D format; and the flag is in the start state and the process proceeds to step S1 in the case that a start signal set by the viewer is detected or no signal set by the viewer is detected, and the flag is adjusted to the stop state and the process ends in the case that a start and stop signal set by the viewer is detected.

Optionally, the system according to the second embodiments of the present disclosure further includes a stereoscopic parallax control module 15. The viewer may adjust the shear angle by using the stereoscopic parallax control module 15. The working principle of the stereoscopic parallax control module 15 is as follows: The stereoscopic parallax control module 15 contains a setting parameter. The players may adjust the setting parameter according to their own needs or choose not to adjust the setting parameter. When the players adjust the setting parameter based on their own feelings and needs, the shear angle changes accordingly in response to the change of the setting parameter. This change enhances or weakens the stereoscopic parallax of their stereoscopic 3D game views, and hence adjusts the strength of the 3D stereoscopic effect. This eventually reduces 3D motion sickness and enhances the 3D experience. When the players choose not to adjust the setting parameter based on their own feelings and needs, the value of the shear angle is calculated based on the eye position parameters obtained in step S2.

Optionally, the stereoscopic parallax control module 15 includes a UI interface or buttons for receiving stereoscopic parallax adjustment instructions from players. It is understood that the components in the stereoscopic parallax control module 15 configured to receive the adjustment instructions from the players are not limited to UI interfaces or buttons; any component capable of receiving the adjustment instructions from the players may be used.

Compared to conventional technologies, the method and system for converting virtual 3D games to stereoscopic 3D games according to the present disclosure achieve the following beneficial effects:

I. In the method for converting virtual 3D games to stereoscopic 3D games according to the present disclosure, first, the eye position parameters of the viewer are acquired; based on the eye position parameters, the rotation angle and the shear angle are calculated; the original virtual 3D view matrix of the game is rotated based in the rotation angle to obtain the stereoscopic view matrix, and the stereoscopic view matrix is sheared based on the shear angle to obtain stereoscopic views from the view points; next, the stereoscopic views from the view points are converted to the views in the predetermined format; and these views in the predetermined format are subjected to layout interleaving processing followed by rendering interleaving processing, and finally vivid stereoscopic 3D game views are generated. Through these steps, the method for converting virtual 3D games to stereoscopic 3D games according to the present disclosure can transform the conventional virtual 3D game scenes to stereoscopic 3D game scenes. Upon the rendering interleaving processing, the display effect of the final stereoscopic 3D game scene is better, and a better immersive experience is provided for the players, and the overall gaming experience of the players is significantly enhanced.

II. In the method for converting virtual 3D games to stereoscopic 3D games according to the present disclosure, first, prior to start of the game, a flag is set, wherein the flag is in a start state and the process continues in the case that the game is in a virtual 3D format, and the flat is in a stop state and the process ends in the case that the game is in a non-virtual 3D format; and second, the flag is in the start state and the process continues in the case that a start signal set by the viewer is detected or no signal set by the viewer is detected, and the flag is adjusted the stop state and the process ends in the case that a start and stop signal set by the viewer is detected. By setting this flag, the gaming system is allowed to determine immediately whether the game can be converted into a stereoscopic 3D game with stereoscopic views. Additionally, the player may manually set a display mode of the game, such that the gaming experience is enhanced.

III. In the method for converting virtual 3D games to stereoscopic 3D games, during acquisition of the eye position parameters, such as the eye distance and the eye rotation angle, of the viewer, through the cooperation of the gyroscope and either a camera or an infrared device, the frequency and accuracy of parameter acquisition are significantly improved. This substantial increases the parameter acquisition frequency, and effectively reduces the image latency caused by movements of the stereoscopic 3D game screen relative to the player, thereby greatly enhancing the gaming experience of the player. Moreover, the enhanced accuracy of the acquired eye position parameters ensures a higher precision in both the rotation angle and the shear angle. This allows the views to appropriately rotate and shear when the player looks at different angles, and hence achieves more vivid and realistic stereoscopic 3D views, thereby providing players with a better immersive gaming experience.

IV. In the method for converting virtual 3D games to stereoscopic 3D games according to the present disclosure, by subjecting the views in the predetermined format to layout interleaving processing and row rendering interleaving processing, the resulting stereoscopic 3D game views are made more vivid and realistic. This optimizes gaming visual experience of the players, further enhances immersive experience of the players, and significantly improves overall gaming experience of the players.

V. In the method converting virtual 3D games to stereoscopic 3D games according to the present disclosure, the players may adjust the shear angle based on their own feelings and needs to enhance or weaken the stereoscopic parallax of the final views, and adjust the strength of the 3D stereoscopic effect. In this way, 3D motion sickness is reduced, and the 3D experience is enhanced.

VI. The present disclosure further provides a system for converting virtual 3D games to stereoscopic 3D games. The system at least includes an eye tracking and positioning module, a 3D view generating module, and a display module. The system achieves the same beneficial effects as the method for converting virtual 3D games to stereoscopic 3D games as described above, which are not described herein any further.

Described above are exemplary embodiments of the present disclosure, but are not intended to limit the scope of the present disclosure. Any equivalent structure or equivalent process variation made based on the specification and drawings of the present disclosure, which is directly or indirectly applied in other related technical fields, fall within the scope of the present disclosure.

1. A naked-eye 3D display method for 2D games, comprising:
S01, acquiring eye position parameters of a viewer, and calculating a viewing distance and a viewing angle between a screen and the viewer at time T1 based on the eye position parameters;
S02, predicting a viewing distance and a viewing angle at time T2 based on gyroscope data and/or button positions and force data; and
S03, converting a 2D game to a 3D game and displaying the 3D game on a naked-eye 3D display device at time T2 based on the viewing distance, a shear angle, and the viewing angle.

2. The naked-eye 3D display method for 2D games according to claim 1, wherein converting the 2D game to the 3D game in S03 comprises:
S031, rotating an original game 3D view matrix of the game to obtain a stereoscopic view matrix based on the viewing angle;
S032, shearing the stereoscopic view matrix based on the shear angle to obtain stereoscopic views from two or more view points;
S033, converting the stereoscopic views from the two or more view points to views in a predetermined format;
S034, performing layout interlacing processing for the views in the predetermined format to acquire 3D game views to be rendered; and
S035, performing rendering interlacing processing for the 3D game views to be rendered to generate 3D game views.

3. The naked-eye 3D display method for 2D games according to claim 2, wherein a formula for calculating the shear angle is calculated is:
wherein coordinates of any point in the stereoscopic views are defined as (x′, y′, z′), sheared coordinates are (x″, y″, z″), and θ is defined as the shear angle and represents an included angle between coordinates of a view point and a positive direction of a z′ axis, t represents an adjustment coefficient and 0<t<1;
a shear expression of an X-axis negative view point is:
$${x}^{″} = {x}^{′} + {z}^{′} * tan ( t * θ ) , {y}^{″} = {y}^{′} , {z}^{″} = {z}^{′} ;$$
and
a shear expression of an X-axis positive view point is:
$${x}^{″} = {x}^{′} - {z}^{′} * tan ( t * θ ) , {y}^{″} = {y}^{′} , {z}^{″} = {z}^{′} .$$

4. The naked-eye 3D display method for 2D games according to claim 2, wherein a formula for calculating the rotating is:
wherein using a screen center as an origin of a coordinate system O-XYZ, an angle between a projection of a connection line from eyes to the screen center on an XOZ plane and a positive half of a Z axis is α, an angle between a projection of the connection line from the eyes to the screen center on a YOZ plane and the positive half of the Z axis is β, and an X-axis direction points from a left screen center to a right screen center;
based on the angle α, the angle β, a distance L from the eyes to the screen, and a distance Z from a scene center to the screen, an angle by which a scene rotates around a Y axis is determined as:
a=arctan(L*tanα/(L+Z)), and
and
an angle by which the scene rotates about an X axis is determined as:
b=arctan(L*tanβ/(L+Z)).

5. The naked-eye 3D display method for 2D games according to claim 1, wherein step S01 comprises:
S011, capturing a facial image by a front camera, and recording image capture time as T1;
S012, calculating facial image feature points using an AI model; and
S013, calculating the viewing distance and the viewing angle based on feature point dimensions and positions of the facial image of a same user during 3D effect calibration.

6. The naked-eye 3D display method for 2D games according to claim 1, wherein step S02 comprises:
S021, continuously sampling the gyroscope and queuing sampled data;
S022, acquiring posture data at time T1 and posture data at current time T of a device, and predicting posture changes of the device from time T to time T2 using a 9-dimensional data AI model; and
S023, calculating a viewing distance and a viewing angle at time T based on the viewing distance and the viewing angle at time T1, and superimposing the posture changes to acquire the viewing distance and the viewing angle at time T2.

7. The naked-eye 3D display method for 2D games according to claim 1, wherein based on the gyroscope data and/or the button positions and force data in S02 comprises:
S02a, configuring a touch screen as a button force sensor;
S02b, establishing an AI model for button force and button positions for posture change training; and
S02c, predicting posture changes based on button force and button positions during a continuous gaming process using the AI model.

8. A naked-eye 3D display system for 2D games, comprising:
an eye tracking and positioning module, configured to acquire eye position parameters of a viewer, and calculate a viewing distance and a viewing angle based on the eye position parameters;
a 3D view generating module, configured to determine a rotation angle and a shear angle based on the viewing distance and the viewing angle, and convert a 2D game to a 3D game and display the 3D game on a naked-eye 3D display device;
a display module, configured to perform layout interlacing processing for the views in the predetermined format to generate 3D game views; and
a raster, configured to perform layout interlacing processing for the views in the predetermined format received by the display module.

9. The naked-eye 3D display system for 2D games according to claim 8, further comprising: a 3D game management module, in gaming, configured to adjust 3D display parameters of the 2D games.

10. The naked-eye 3D display system for 2D games according to claim 8, further comprising: a gyroscope and a force sensor.
